(19) United States
(12) Patent Application Publication
(10) Pub. No.: US 2017/0308190 A1
(43) Pub. Date: Oct. 26, 2017

(54) CAPACITIVE STYLUS WITH POWER SAVING APPARATUS

(71) Applicant: WALTOP INTERNATIONAL CORPORATION, Hsinchu City (TW)

(72) Inventors: Ying Hwa Tang, Hsinchu City (TW); Chih Hung Huang, Hsinchu City (TW); A-Li Wong, Hsinchu City (TW)

(21) Appl. No.: 15/162,410

(22) Filed: May 23, 2016

(30) Foreign Application Priority Data
Apr. 20, 2016 (TW) 105112349

(51) Int. Cl. G06F 3/0354; G06F 3/038; G06F 1/32; G06F 3/044

(52) U.S. Cl. CPC G06F 3/03545; G06F 3/044; G06F 1/3215; G06F 1/3259; G06F 3/038

(57) ABSTRACT

A capacitive stylus with a power saving apparatus is disclosed. The capacitive stylus uses a controller to control a stylus circuit to output a high voltage when the capacitive stylus accelerates or moves so as to save electrical power of the capacitive stylus.

### CROSS-REFERENCE TO RELATED APPLICATIONS

The entire contents of Taiwan Patent Application No.105112349, filed on Apr. 20, 2016, from which this application claims priority, are expressly incorporated herein by reference.

### 1. Field of the Invention The present invention relates to a capacitive stylus, and more particularly to a capacitive stylus with a power saving apparatus.

### 2. Description of the Prior Art

Touch panels which widely use capacitive touch input technology, not only allow user to proceed input operation via user's hand so as to have a multi touch function which can generate a variety of applications according to specific corresponding operations by various gestures, but also allow user to utilize a capacitive pointer to perform exquisite input operations such as writing or to execute application programs on a touch panel via user interfaces. The coordinates of a capacitive pointer can be detected via capacitive coupling between detection electrodes of a touch panel and the capacitive pointer when the capacitive pointer approaches or contacts the touch panel. In order to establish capacitive coupling with detection electrodes of a touch panel, a capacitive pointer must receive driving signals from detection electrodes and output signals to detection electrodes so that coordinates of the capacitive pointer can be detected. In order to maintain operation, a capacitive pointer must continue receiving driving signals from detection electrodes and outputting signals. However, continuing to output signals is not always necessary and continuous high voltage output also consumes electrical energy quickly. Thus the invention provides a capacitive stylus with a power saving apparatus which outputs high voltage signals when the capacitive stylus accelerates or moves so as to save unnecessary electrical power consumption and to achieve objective of power saving.

### SUMMARY OF THE INVENTION

An object of the present invention is to provide a capacitive stylus with a power saving apparatus which uses a controller to control a stylus circuit to output a high voltage when the capacitive stylus accelerates or moves so as to save electrical power of the capacitive stylus.

According to the object, one embodiment of the present invention provides a capacitive stylus with a power saving apparatus comprising a controller, a motion sensor and a power circuit. The power circuit regulates or converts a voltage from a power source to the controller, wherein the controller controls the capacitive stylus to output a voltage signal or to stop outputting a voltage signal according to whether the motion sensor detect an accelerations or a motion of the capacitive stylus or not.

Another embodiment of the present invention provides a capacitive stylus with a power saving apparatus comprising a controller, a motion sensor and a power circuit comprising a switch circuit. The motion sensor outputs a first signal to the power circuit when the motion sensor detects an acceleration or a motions of the capacitive stylus, the power circuit regulates or converts a voltage from a power source so that the controller controls the capacitive stylus to output a first voltage signal.

Another embodiment of the present invention provides a capacitive stylus with a power saving apparatus comprising a controller, a power circuit and a motion sensor. The power circuit regulates or converts a voltage from a power source to the controller. The motion sensor outputs a first signal to the controller when the motion sensor detects an acceleration or a motions of the capacitive stylus, and the controller controls the capacitive stylus to output a first voltage signal.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1A is a schematic block diagram of a capacitive stylus with a power saving apparatus according to one embodiment of the invention.

FIG. 1B is a schematic block diagram of a capacitive stylus with a power saving apparatus according to another embodiment of the invention.

FIG. 1C is a schematic block diagram of a capacitive stylus with a power saving apparatus according to another embodiment of the invention.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in details, it is appreciated that the scale of each component may not be expressly exactly.

In embodiments of the invention, some features related to a capacitive stylus which are not essential to the invention and are well known for any person skilled in the art to make and use the same will not be described in detail herein. For example, the following features relating to a capacitive stylus and a touch panel are well known for any person skilled in the art to make and use the same. A capacitive stylus includes a conductive nib, a pressure sensor, an amplifier circuit, a comparator circuit, and a boost circuit which provides high voltage outputs, etc. While a touch panel has a capacitive detection array with a plurality of detection electrodes, wherein the detection electrodes comprise transmitting electrodes (Tx) and receiving electrodes (Rx). When a capacitive stylus is used upon a touch panel, the conductive nib approaches or contacts the capacitive detection array of the touch panel, and the conductive nib of the capacitive stylus will establish capacitive coupling with the detection electrodes under or adjacent the capacitive stylus which provide the capacitive stylus with driving signals. The capacitive stylus outputs a signal to the detection electrodes under or adjacent the capacitive stylus after receiving and processing the driving signals. Through capacitive coupling between the conductive tip and the detection electrodes, the signal from the capacitive stylus will be detected during scanning transmitting electrodes and receiving electrodes so that coordinates of the capacitive stylus can be calculated and determined. The capacitive detection array can use charge accumulation circuit, a capacitance modulation circuit, or other capacitance sensing methods known by those skilled in the art.

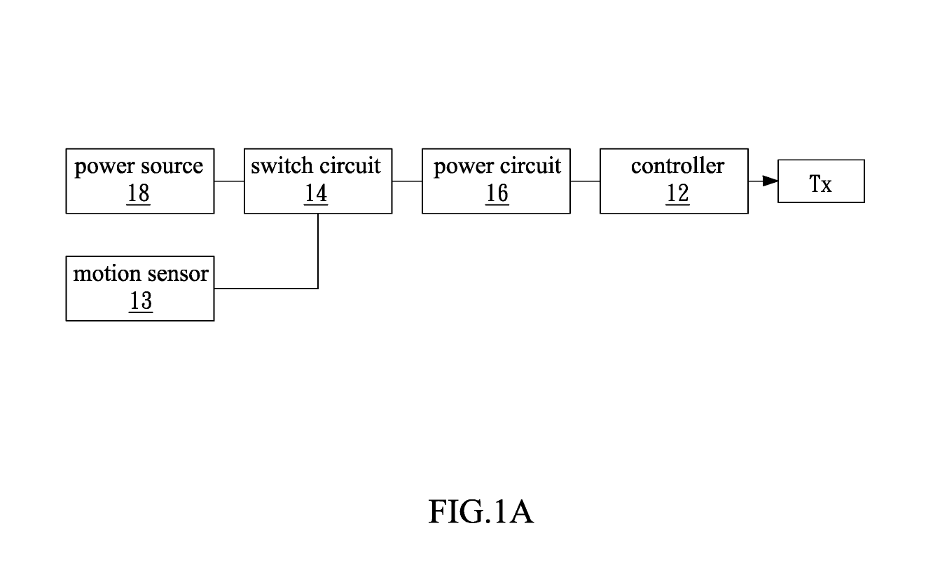

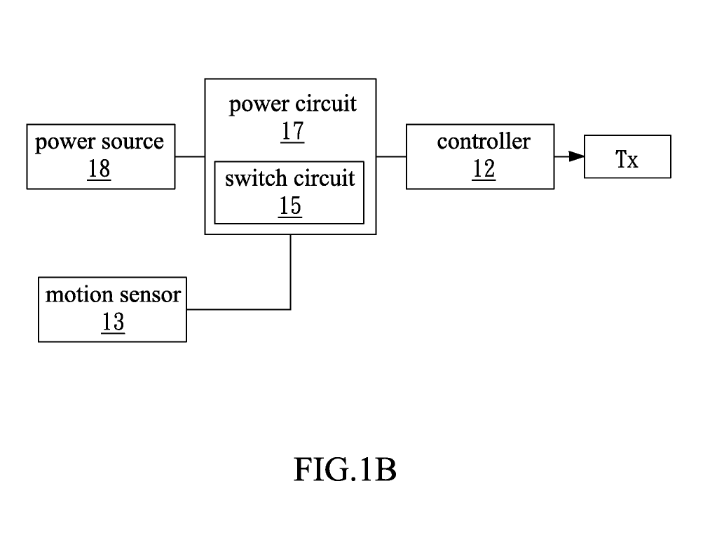

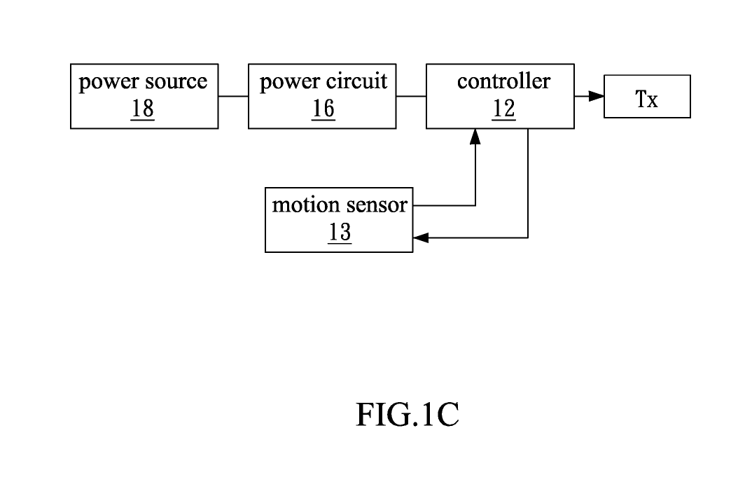

FIG. 1A is a schematic block diagram of a capacitive stylus with a power saving apparatus according to one embodiment of the invention. In this embodiment, the capacitive stylus comprises a controller 12, a motion sensor 13, a switch circuit 14, a power circuit 16 and a power source 18. The switch circuit 14 comprises metal oxide semiconductor devices, transistors resistors, capacitors or any suitable devices. The power circuit 16 comprises a voltage regulator or a voltage converter which can alter voltages from the power source 18 to the controller 12. The power source 18 comprises batteries. The motion sensor 13 comprises a micro-electro-mechanical systems (MEMS) chip, such as accelerometer and gyroscope, etc.

In this embodiment, the capacitive stylus with a power saving apparatus utilizes the motion sensor 13 to control the switch circuit 14 to drive the power circuit 16 to regulate or convert voltage outputs from the power source 18 to the controller 12.

The motion sensor 13 outputs signals to the switch circuit 14 when the motion sensor 13 detects accelerations or motions of the capacitive stylus. The switch circuit 14 drives the power circuit 16 according to the signals to regulate or convert voltage outputs from the power source 18 to the controller 12 so that the power circuit 16 provides the controller 12 with higher voltage outputs and the controller 12 controls the capacitive stylus to output high voltage signals. The motion sensor 13 outputs other signals to the switch circuit 14 or does not output any signal when the motion sensor 13 does not detect any acceleration or motion of the capacitive stylus. The switch circuit 14 drives the power circuit 16 to regulate or convert voltage outputs from the power source 18 to the controller 12 so that the power circuit 16 provides the controller 12 with lower voltage outputs and the controller 12 controls the capacitive stylus to stop outputting high voltage signals or to lower voltages of high voltage signals so as to save power consumption of the capacitive stylus.

FIG. 1B is a schematic block diagram of a capacitive stylus with a power saving apparatus according to another embodiment of the invention. In this embodiment, the capacitive stylus comprises a controller 12, a motion sensor 13, a power circuit 17 and a power source 18. The power circuit 17 includes a switch circuit 15 therein. The switch circuit 15 comprises metal oxide semiconductor devices, transistors resistors, capacitors or any suitable devices. The power circuit 17 comprises a voltage regulator or a voltage converter which can alter voltages from the power source 18 to the controller 12.

In this embodiment, the capacitive stylus with a power saving apparatus utilizes the motion sensor 13 to control the power circuit 17, and uses the switch circuit 15 to control the power circuit 17 regulate or convert voltage outputs from the power source 18 to the controller 12. The motion sensor 13 outputs signals to the power circuit 17 when the motion sensor 13 detects accelerations or motions of the capacitive stylus. The switch circuit 15 drives the power circuit 16 according to the signals to drive the power circuit 17 to regulate or convert voltage outputs from the power source 18 to the controller 12 so that the power circuit 17 provides the controller 12 with higher voltage outputs and the controller 12 controls the capacitive stylus to output high voltage signals. The motion sensor 13 outputs other signals to the power circuit 17 or does not output any signal when the motion sensor 13 does not detect any acceleration or motion of the capacitive stylus. The switch circuit 15 drives the power circuit 17 to regulate or convert voltage outputs from the power source 18 to the controller 12 so that the power circuit 17 provides the controller 12 with lower voltage outputs and the controller 12 controls the capacitive stylus to stop outputting high voltage signals or to lower voltages of high voltage signals so as to decrease power consumption of the capacitive stylus.

FIG. 1C is a schematic block diagram of a capacitive stylus with a power saving apparatus according to another embodiment of the invention. In this embodiment, the capacitive stylus comprises a controller 12, a motion sensor 13, a power circuit 16 and a power source 18. In this embodiment, the capacitive stylus with a power saving apparatus utilizes the motion sensor 13 to output signals to the controller 12 so that the controller 12 controls a stylus circuit to determine whether the stylus circuit outputs high voltage signals.

The motion sensor 13 outputs signals to the controller 12 when the motion sensor 13 detects accelerations or motions of the capacitive stylus. The controller 12 controls the stylus circuit to output high voltage signals according to the signals of the motion sensor 13. The motion sensor 13 outputs other signals to the controller 12 or does not output any signal when the motion sensor 13 does not detect any acceleration or motion of the capacitive stylus. The controller 12 controls the stylus circuit to stop outputting high voltage signals or to lower voltages of high voltage signals so as to save power consumption of the capacitive stylus.

The schematic block diagrams illustrating various embodiments of a capacitive stylus with a power saving apparatus shown in FIGS. 1A, 1B and 1C are examples only, not limitations. Other circuit arrangements or devices can be applied in the embodiments according to various designs and requirements.

The capacitive stylus with a power saving apparatus of the claimed invention outputs high voltage signals only when a motion sensor detects acceleration or motion of the capacitive stylus. The capacitive stylus would stop outputting high voltage signals or lower voltages of the high voltage signals so as to save power consumption of the capacitive stylus.

Although specific embodiments have been illustrated and described, it will be appreciated by those skilled in the art that various modifications may be made without departing from the scope of the present invention, which is intended to be limited solely by the appended claims.

What is claimed is:

1. A capacitive stylus with a power saving apparatus, comprising:
a controller;
a motion sensor; and
a power circuit, the power circuit regulating or converting a voltage from a power source to the controller, wherein the controller controls the capacitive stylus to output a voltage signal or to stop outputting a voltage signal according to whether the motion sensor detect an accelerations or a motion of the capacitive stylus or not.

2. The capacitive stylus according to claim 1 further comprising a switch circuit, the motion sensor controlling the switch circuit to drive the power circuit to regulate or convert the voltage from the power source to the controller.

3. The capacitive stylus according to claim 2, wherein the motion sensor outputs a first signal to the switch circuit when the motion sensor detects an acceleration or a motion of the capacitive stylus.

4. The capacitive stylus according to claim 3, wherein the switch circuit drives the power circuit according to the first signal to regulate or convert the voltage from the power source to the controller so that the controller controls the capacitive stylus to output the voltage signal, and the voltage signal is a high voltage signal.

5. The capacitive stylus according to claim 2, wherein the motion sensor outputs a second signal to the switch circuit when the motion sensor does not detect an acceleration or a motion of the capacitive stylus.

6. The capacitive stylus according to claim 5, wherein the switch circuit drives the power circuit according to the second signal to regulate or convert the voltage from the power source to the controller so that the controller controls the capacitive stylus to output the voltage signal, and the voltage signal is a low voltage signal.

7. The capacitive stylus according to claim 5, wherein the switch circuit drives the power circuit according to the second signal to regulate or convert the voltage from the power source to the controller so that the controller controls the capacitive stylus to stop outputting the voltage signal.

8. The capacitive stylus according to claim 2, wherein the motion sensor does not output any signal to the switch circuit when the motion sensor does not detect an acceleration or a motion of the capacitive stylus.

9. The capacitive stylus according to claim 1, wherein the motion sensor comprises a micro-electro-mechanical systems chip.

10. The capacitive stylus according to claim 1, wherein the motion sensor comprises an accelerometer and a gyroscope.

11. A capacitive stylus with a power saving apparatus, comprising:
a controller;
a motion sensor; and
a power circuit comprising a switch circuit, the motion sensor outputting a first signal to the power circuit when the motion sensor detects an acceleration or a motions of the capacitive stylus, the power circuit regulating or converting a voltage from a power source so that the controller controls the capacitive stylus to output a first voltage signal.

12. The capacitive stylus according to claim 11, wherein the first voltage signal is a high voltage signal.

13. The capacitive stylus according to claim 11, wherein the motion sensor outputs a second signal to the power circuit when the motion sensor does not detect an acceleration or a motion of the capacitive stylus.

14. The capacitive stylus according to claim 13, wherein the switch circuit drives the power circuit according to the second signal to regulate or convert the voltage from the power source to the controller so that the controller controls the capacitive stylus to output a second voltage signal, and the second voltage signal is a low voltage signal.

15. The capacitive stylus according to claim 13, wherein the switch circuit drives the power circuit according to the second signal to regulate or convert the voltage from the power source to the controller so that the controller controls the capacitive stylus to stop outputting any voltage signal.

16. The capacitive stylus according to claim 11, wherein the motion sensor does not output any signal to the power circuit when the motion sensor does not detect an acceleration or a motion of the capacitive stylus.

17. A capacitive stylus with a power saving apparatus, comprising:
a controller;
a power circuit, the power circuit regulating or converting a voltage from a power source to the controller; and
a motion sensor, the motion sensor outputting a first signal to the controller when the motion sensor detects an acceleration or a motions of the capacitive stylus, and the controller controlling the capacitive stylus to output a first voltage signal.

18. The capacitive stylus according to claim 17, wherein the first voltage signal is a high voltage signal.

19. The capacitive stylus according to claim 17, wherein the motion sensor outputs a second signal to the controller or does not output any signal when the motion sensor does not detect an acceleration or a motion of the capacitive stylus.

20. The capacitive stylus according to claim 19, wherein the controller controls the capacitive stylus to output a second voltage signal or to stop outputting any voltage signal according to the second signal, and the second voltage signal is a low voltage signal.
